(19) United States
(12) Patent Application Publication
(10) Pub. No.: US 2025/0234331 A1
(43) Pub. Date: Jul. 17, 2025

(54) USER EQUIPMENT LOCALIZATION USING DIGITAL REPLICA RF MAPS

(71) Applicant: ARIZONA BOARD OF REGENTS ON BEHALF OF ARIZONA STATE UNIVERSITY, Scottsdale, AZ (US)

(72) Inventors: Ahmed Alkhateeb, Chandler, AZ (US); Joao Morais, Tempe, AZ (US)

(73) Assignee: ARIZONA BOARD OF REGENTS ON BEHALF OF ARIZONA STATE UNIVERSITY, Scottsdale, AZ (US)

(21) Appl. No.: 19/014,764

(22) Filed: Jan. 9, 2025

Related U.S. Application Data
(60) Provisional application No. 63/619,901, filed on Jan. 11, 2024.

(51) Int. Cl. H04W 64/00; H04B 17/391; H04W 24/06

(52) U.S. Cl. CPC H04W 64/006; H04B 17/3912; H04W 24/06

(57) ABSTRACT

A system and method using a digital replica to populate large fingerprinting databases. A digital twin map is created ray-tracing simulations on a digital replica of the environment across several frequency bands and beamforming configurations. Online user equipment fingerprints are matched against this spatial database. A user equipment position measured in real-time and the digital twin map are used to compute the most probable location of the user equipment.

### GOVERNMENT FUNDING

This invention was made with government support under contract number 2048021 awarded by the National Science Foundation. The government has certain rights in the invention.

### TECHNICAL FIELD

The present disclosure relates to localization in wireless networks.

### BACKGROUND

Precise localization of mobile terminals can bring societal benefits, enabling use cases both for industries and consumers, and permitting network design, management, and optimization. In wireless networks, localization can be done with triangulation (via angle estimation) or trilateration (via estimation of signal propagation time and hence the distance between transmit-receive points). These networks operate in line-of-sight (LoS), and are accompanied by the transmission of high-bandwidth reference signals from multiple access points (APs). These APs may be synchronized on the order of nanoseconds. Some localization methods are associated with multiple input multiple output (MIMO) antenna systems in 4G/5G and Wi-Fi 4 (802.11n) technologies. Multiple antennas can enable multipath exploitation techniques, which can work in non-LoS (NLoS) situations, and with a single base station. These techniques require specialized hardware and high temporal and spatial resolution, thus imposing high communication overhead and making them unscalable for transparent massive multi-user tracking.

Fingerprinting, a technique that can address the limitations of other systems, includes determining user equipment (UE) location by pattern-matching measurements with database entries that have locations associated with entries. To build a database with the measurements and their locations, crowd-sourcing and sensor-based dead-reckoning/tracking can be used. Large databases have been found to be more likely to perform better, and fingerprinting localization needs high bijectiveness between features and positions. What is needed is a method for building massive databases efficiently.

### SUMMARY

A system and method in accordance with embodiments of the present disclosure include digital twin RF maps, calculated with ray tracing in a digital replica of the target environment, to populate fingerprinting databases and localize UEs in the real world. Systems and methods for populating large fingerprinting databases in accordance with embodiments of the present disclosure create digital twin (DT) radiofrequency (RF) maps. A digital replica of reality is created and used to compute RF map fingerprints. Building database fingerprints with DT RF maps creates large localization databases that can improve performance over smaller databases. Other information can be included in the created databases that can improve positioning. Received signal strength (RSS) measurements from multiple beams and subbands can be used to achieve positioning accuracy. The system and method can use simulated information, including multiple base stations, timing/angle/distance data, channel state information such as precoding indicators, and external information like UE inertial sensors or traffic cameras.

DT RF maps reduce human effort in fingerprinting localization, allowing deployments at scale and improved positioning accuracy. The system and method analyze joint time-frequency-space fingerprinting potential using ray tracing simulations. The system and method do not require LoS, multiple base stations (BSs), dedicated hardware, reference signals, or channel estimation. The system and method can be applied for sub-6 GHz deployments where bandwidth is scarce and UEs are in NLoS, and where larger antenna arrays are more available.

The system and method define how the RSS on a given beam and subband is measured, and how multiple measurements are weighted at the BS to extract a location estimate. In the system and method of the present disclosure, 3D maps of the environment form a digital twin of reality, and ray tracing simulations compute propagation paths. The propagation paths are converted into channels and used to build DT RF maps to populate fingerprinting databases.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes claims a method for localizing user equipment (UE) in an area. The method includes creating a 3D map of the area, creating a digital replica based on an electromagnetic simulation of locations on the 3D map, generating fingerprinting maps for a simulated parameter for the digital replica, and measuring a wireless communications-related parameter at a position of the UE. The method also includes computing a likelihood of the position of the UE based on the measured wireless communications-related parameter and a subset of the digital replica simulated parameter. The method also includes choosing the position associated with the likelihood that is larger than other of the likelihoods. Other embodiments of this aspect include corresponding computer systems, apparatus, and computer programs recorded on one or more computer storage devices, each configured to perform the actions of the methods.

Implementations may include one or more of the following features. The electromagnetic simulation may include ray tracing. The wireless communications-related parameter may include a received signal strength. The method may include creating a digital twin map based on ray tracing in the digital replica, and/or calibrating the digital twin map, and/or creating a digital twin map based on near real-time measurements and/or sensing data in the area, and/or calibrating the digital twin map based on near real-time measurements and/or sensing data in the area, and/or basing creating of the 3D map at least on real-time or near real-time dynamics of the area, and/or creating a digital twin map based at least on sensed data. The 3D map may include a real-time 3D map. Implementations of the described techniques may include hardware, a method or process, or computer software on a computer-accessible medium.

One general aspect includes a computer system for localizing UE in an area based on wireless measurements. The computer system includes a hardware processor, and a non-volatile storage medium storing instructions that when executed by the hardware processor perform operations. The operations may include creating a 3D map of the area, creating a digital replica based on an electromagnetic simulation of locations on the 3D map, generating fingerprinting maps for a simulated parameter for the digital replica, and measuring a wireless communications-related parameter at a position of the UE. The operations also include computing a likelihood of the position of the UE based on the measured wireless communications-related parameter and a subset of the digital replica simulated parameter, and choosing the position associated with the likelihood that is larger than other of the likelihoods. Other embodiments of this aspect include corresponding computer systems, apparatus, and computer programs recorded on one or more computer storage devices, each configured to perform the actions of the methods.

Implementations may include one or more of the following features. The operations further may include creating a digital twin map based on ray tracing in the digital replica, and/or calibrating the digital twin map, and/or creating a digital twin map based on near real-time measurements and/or sensing data in the area, and/or creating a digital twin map based at least on sensed data. Implementations of the described techniques may include hardware, a method or process, or computer software on a computer-accessible medium.

One general aspect includes a computer program product for localizing UE in an area based on wireless measurements. The computer program product includes a computer readable storage medium having program instructions embodied therewith, the program instructions executable by a computing device to cause the computing device to perform operations including creating a 3D map of the area, creating a digital replica based on an electromagnetic simulation of locations on the 3D map, generating fingerprinting maps for a simulated parameter for the digital replica, and measuring a wireless communications-related parameter at a position of the UE. The operations also include computing a likelihood of the position of the UE based on the measured wireless communications-related parameter and a subset of the digital replica simulated parameter, and choosing the position associated with the likelihood that is larger than other of the likelihoods. Other embodiments of this aspect include corresponding computer systems, apparatus, and computer programs recorded on one or more computer storage devices, each configured to perform the actions of the methods.

### BRIEF DESCRIPTION OF THE DRAWINGS

The subject matter of the present disclosure is particularly pointed out and distinctly claimed in the concluding portion of the specification. A more complete understanding of the present disclosure, however, may be obtained by referring to the detailed description and claims when considered in connection with the drawing figures, wherein like numerals denote like elements.

FIG. 1 is an illustration of a real-world communication system and its digital replica;

FIG. 2 is an illustration of an end-to-end fingerprinting-based localization system leveraging an offline-built digital twin built from ray tracing simulations on UE locations on a 3D map of the deployment, the twin generating RF Maps for RSS values (or other simulated data) for different beams and subbands, the DT RF maps being updated or calibrated with real-world information, the DT RF maps being used in near real-time with online real-world UE measurements to extract location probabilities and make a localization estimate decision;

FIG. 3 is an illustration of localization accuracy for UE positions in a 2D grid at a height of two meters (6.5 feet) created using a scenario with six buildings using the baseline reporting parameters: no. beams | [symbol] |=1, number of subbands | [symbol] |=1, and number of reports in time | [symbol] |=1, where the base station (BS) uses a 64-antenna ULA with position and orientation represented, and position 1 (50 m from BS, LoS) and position 2 (80 m from BS, NLoS) are used;

FIG. 4 is a graphical illustration of the impact of several reporting parameter combinations on localization error for position 1 (LoS), where RSS measurements in more beams, (| [symbol] |), subbands (| [symbol] |) and repeated measurements across time (| [symbol] |) individually jointly improve fingerprinting accuracy;

FIG. 5 is a graphical illustration of the impact of reporting parameter combinations on localization error for position 2 non-line of sight (NLoS), where localization error is affected by more RSS measurements in distinct beams;

FIG. 6 is a table relating the time in positions 1 (LoS) and 2 (non-LoS) and parameter combinations (beams, subbands, and time); and

FIG. 7 is a flowchart of a method in accordance with embodiments of the present disclosure.

### DETAILED DESCRIPTION

The detailed description of various embodiments herein makes reference to the accompanying drawings and pictures, which show various configurations by way of illustration. While these various configurations are described in sufficient detail to enable those skilled in the art to practice the disclosure, it should be understood that other configurations may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, the functions or steps may be outsourced to or performed by one or more third parties. Furthermore, reference to singular includes plural embodiments, and reference to more than one component may include a singular embodiment.

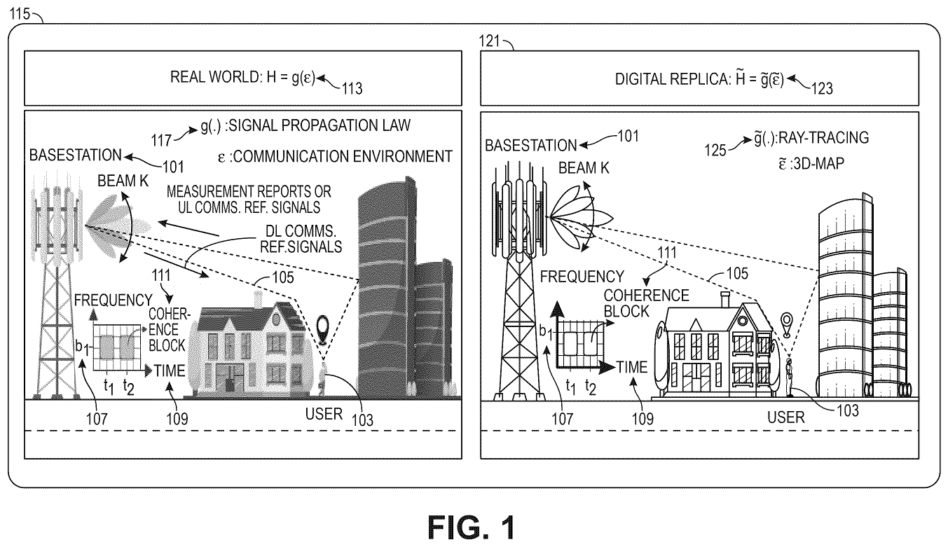

Referring now to FIG. 1, a MIMO communication system includes a base station (BS) 101 with Nₜ antennas that communicates with UEs 103 that are equipped with Nᵣ antennas. H∈ [symbol] represents the over-the-air complex channel matrix. The downlink receive signal 105 at the UE 103 in a narrowband time-frequency coherence block defined in subband b 107 and time t 109 is given by

$$y [ ] = {w}^{H} {H}_{b} [ ] [ ] + {w}^{H} n \qquad ( 1 )$$

with x and y being the transmitted and received symbols in the coherence block, with x agreeing with per-symbol power constraint [symbol] [| [symbol] |²]=Pₜ, where Pₜ is the transmit power. The beamforming vector [symbol] ∈ [symbol] follows per-antenna power constraints, i.e., | [symbol] |≤1. The vector w∈ [symbol] represents the receive combining vector and n˜ [symbol] (0, σ²) is the receive noise vector.

Continuing to refer to FIG. 1, the UE 103 can be localized based on wireless measurements. The channel matrix H in Eq. (1) depends on the UE position and the propagation (communication) environment 113. The UE position can be estimated given channel knowledge such as, for example, but not limited to, received signal strength (RSS) measured across different beams and sub-bands. The considered measurement is the RSS measurement by the UE at times that are different from each other that match transmission beams at the BS and in subbands that are different from each other. Subbands are considered different from each other if one of the limits of the interval is different. The intervals may overlap. The considered measurement is defined and the UE localization problem is formulated in terms of the channel knowledge. With respect to downlink transmission, the UE 103 measures the RSS across multiple BS transmit beams, subbands, and time blocks, and feeds the measurements to the BS 101. The subband b 107 and time t 109 indices localize a time-frequency coherence block and k is the index of the BS beam [symbol] ₖ in the codebook [symbol] where the RSS measurement takes place. In the case of single antenna UE, i.e. Nᵣ=1, the RSS measured in the coherence block (b,t), a UE position p and BS beam k can be written as

$${RSS}_{p} ( k , b , t ) = {\vert {y}_{p} ( {k}_{} , {H}_{b} [ ] ) \vert}^{2} \qquad ( 2 )$$

Continuing to refer to FIG. 1, RSS measurements in the coherence block 111 and on a given beam have approximately the same received power value. When the measurements take place in different beams, subbands, and time slots, the result is a measurement set ηₚ be formulated as

$${η}_{p} ( , , 𝒯 ) = \{ {RSS}_{p} ( k , b , t ) : k ∈ , b ∈ , t ∈ 𝒯 \} \qquad ( 3 )$$

where [symbol] , [symbol] , and [symbol] , are, respectively, the sets of beams, subbands, and time blocks where measurements occurred. Measurements are on a timescale where the position can be considered constant. The measurements are not aggregated together to estimate a single position. The larger sets ( [symbol] , [symbol] , and [symbol] ) hold more information about the UE position than the smaller sets, which can enable enhanced localization performance.

The set of the N_{K} received power beams, for example, but not limited to, the highest received power beams, is

$$( {N}_{K} ) = {{argmax}_{{′}^{} ⊂ \{ 1 .. \vert ℱ \vert \}}}_{\vert {′}^{} \vert = {N}_{K}} {\sum }_{k ∈ {′}^{}} {RSS}_{p} ( k , b , t ) \qquad ( 4 )$$

where the BS codebook size is denoted by | [symbol] |. With the set of measurements ηₚ defined, the UE 103 can be localized using [symbol] ′ (ηₚ( [symbol] , [symbol] , [symbol] ) where [symbol] ′ is a mapping (localization) function that can localize the UE 103 given the reported measurements. The mapping function is learned and optimized by the methods disclosed herein. [symbol] represents the position dataset collected for optimizing the mapping/localization function (for example, the fingerprinting database). The mapping function is

$$ℒ = {argmin}_{{ℒ}^{′}} {𝔼}_{} \vert p - {ℒ}^{′} ( {η}_{p} ( , , 𝒯 ) ) \vert \qquad ( 5 )$$

where [symbol] is a target mapping function, for example, k-nearest neighbors. The system and method estimate the UE position from the sets of measurements ηₚ. The system and method are applicable to MIMO systems, including Wi-Fi and cellular networks.

Continuing to refer to FIG. 1, the localization function [symbol] maps a set of measurements ηₚ to a location of the UE 103 using a DT 121 of the environment to build synthetic RF maps, i.e., a fingerprinting database. A DT 121 can be created using the 3D maps 123 of the environment, ideally fused with the material properties and the real-time dynamics obtained from various sensing information. An approximation of real propagation can be obtained by performing electromagnetic simulations, such as ray tracing, in the DT.

To approximate the digital twin, [symbol] 123 is a 3D model approximation of the real world [symbol] 115 (including the material characteristics). Ray tracing 125 is the approximation \tilde{g}(⋅) of the propagation laws 117 of nature g(⋅). The real and digital wireless channels are

$$H = g ( ℰ ) \tilde{H} = \tilde{g} ( \tilde{ℰ} ) \qquad ( 6 )$$

The 3D map 123 and ray tracing 125 are used to construct the channels in the DT 121. The 3D maps 123, possibly static or dynamically updated in real-time, are used in ray tracing 125 to generate channel parameters such as angles of arrival (AoA) and angles of departure (AoD) for paths propagating from the transmitter to the receiver. A geometric channel model can be utilized to construct the channel matrix. The approximation of the channel impulse response \tilde{h}_{i,j}(t) between a transmit-receive antenna pair in the digital replica 121 can be written as the sum of L multi-path components:

$${\tilde{h}}_{, j} ( t ) = {\sum }_{l = 1}^{L} {α}_{l} δ ( t - {τ}_{l} ) {G}_{i} ( {ϕ}_{l}^{AoA} , {θ}_{l}^{AoA} ) {G}_{j} ( {ϕ}_{l}^{AoD} , {θ}_{l}^{AoD} ) \qquad ( 7 )$$

where αₗ and [symbol] ₗ represent the complex gain and propagation delay of the l-th path, and the azimuth and elevation angles of arrival and departure of this path are respectively denoted by ϕₗ^{AoA}, θₗ^{AoA}, ϕₗ^{AoD} and θₗ^{AoD}. Gᵢ and Gⱼ are the radiation patterns of the receive and transmit antennas.

The channels can be used to populate a DT database according to Eq. (2) with the simulated RSSs denoted by [symbol] (k, b) The database has dimensions [D_{K}, D_{B}, D_{P}], where D_{K}=| [symbol] | is the number of BS beams, D_{B} is the number of subbands and D_{P} is the number of simulated positions in a 3D UE grid. The database represents synthetic DT RF maps with simulated RSS values.

When the UE reports the real-world measurement RSSₚ(k, b, t) the DT RF maps are used to compute a 3D probability grid of where the UE is more likely to be in the position space. This is achieved by computing the overall perceived probability of a UE being in position p′ given the set of measurements ηₚ( [symbol] , [symbol] , [symbol] ), according to

$$ℙ ( p = {p}^{′} \vert {η}_{p} ( , , 𝒯 ) ) \qquad ( 8 )$$

This probability distribution is calculated based on measurements from the DT 121.

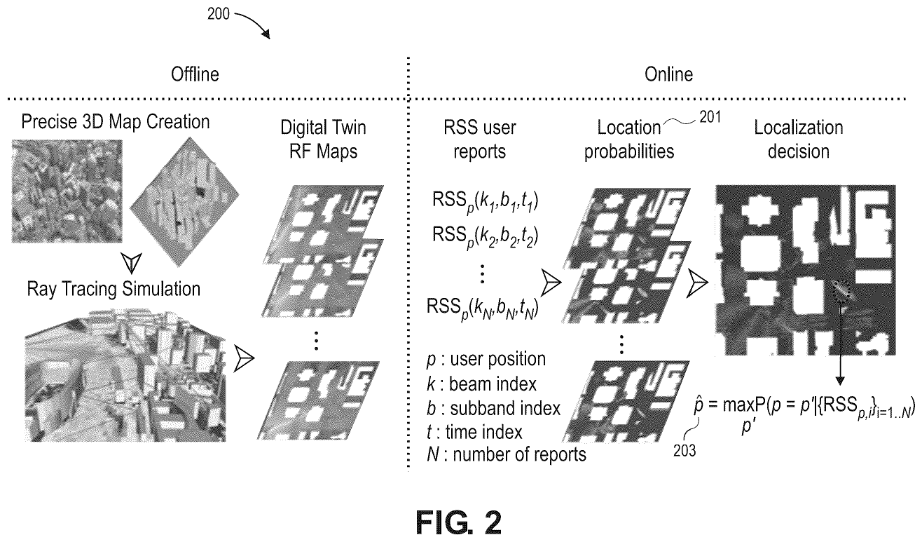

Referring now to FIG. 2, a localization workflow 200 in accordance with the present disclosure is summarized. Eq. (8) is used to obtain the location probability 201 of a UE being in position p′ given a set of real-world measurements ηₚ. The measurements in the set give rise to a location probability, which is computed by assuming a measurement probability distribution composed of real-world measurements and/or digital twin results. The likelihood of UE being in position p′ is computed. The position estimate \hat{p} 203 is computed by repeating the position likelihood computation for positions in the DT database to determine a relatively high probability. Mathematically.

$$\hat{p} = ( {η}_{p} ( , , 𝒯 ) ) = {max}_{{p}^{′}} ℙ ( p = {p}^{′} \vert {η}_{{p}^{′}} ( , , 𝒯 ) ) \qquad ( 9 )$$

where [symbol] is the positioning function found by a probability based method. According to the information in the DT database, this localization function attempts to minimize the localization error given by

$$ϵ = \vert p - \hat{p} \vert \qquad ( 10 )$$

for a set of measurements ηₚ (subject to the DT modeling accuracy). The relationship between a larger number of measurements/fingerprints and an increased accuracy in location determination provides an indication of the efficacy of a system and method in accordance with embodiments of the present disclosure.

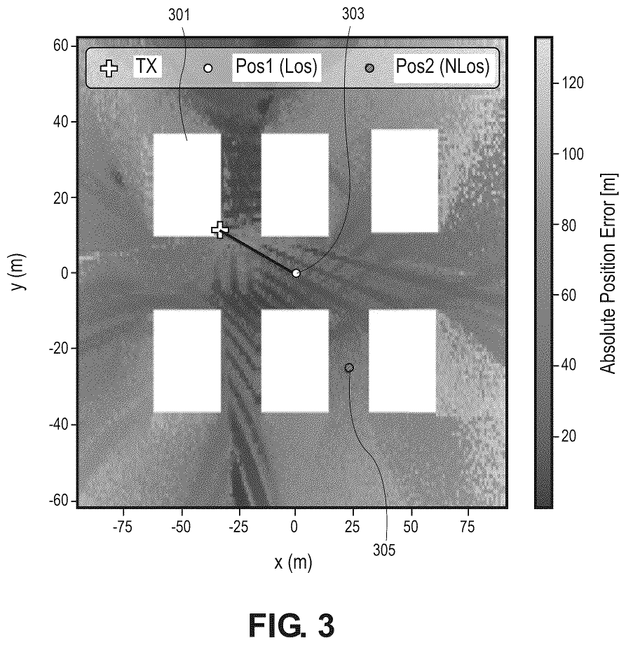

Referring now to FIG. 3, to evaluate the relationship, three dimensions are considered: beams reported (| [symbol] |), reported subbands (| [symbol] |), and reports in time (| [symbol] |). A DT database is used to perform the evaluation. To create the DT database, ray tracing simulations are performed with six buildings 301. The database grid spans an area of 180×140 meters at a height of two meters with a resolution of two meters. The result is a uniform grid of 91×71 positions, 6461 in total. The positions inside buildings are not included, narrowing the possible UE positions down to 4286. The top view of this scenario is shown in FIG. 3. The ray tracing simulations use a depth of five reflections with enabled scattering and diffusion but no material penetration. The simulator sends rays from the BS in five million directions to detect the power contributions from the paths towards the UE. After ray tracing the paths, a deep learning dataset for millimeter wave and massive MIMO systems is used to generate orthogonal frequency-division multiplexing (OFDM) channels. These channels have 15 kHz subcarriers (numerology 0 in 5G) that span a bandwidth of 20 MHz. The channel response of these subcarriers in subbands of 1 MHz is aggregated and repeated for positions and beamformers/beams to evaluate. Data are sampled from random distributions instead of collecting real-world RSS measurements. The measured RSS follows a normal distribution, i.e. RSSₚ(k, b, t)˜ [symbol] (μₚ(k, b), σₚ(k, b)), μₚ(k, b)= [symbol] (k, b), where [symbol] (k, b) is a ray-traced RSS value for position p in beam k and band b. For the standard deviation, σₚ(k, b)=σ_{def} with σ_{def}=2 dBm. This choice guarantees 99% of measurements within ±6 dB of the mean, which agrees with reported variations between 5 and 7 dB for immobile UEs.

The probability likelihood on the right-hand side of Eq. (9) is defined to compute the locations of UE. The probability likelihood depends on the assumptions on the wireless channel, and independent fading realizations in consecutive coherence intervals are considered, providing an approximate lower bound on localization accuracy because the correlated information across measurements is not used. Under the assumption that measurements RSSₚ(k, b, t) performed in different beams and different coherence blocks are independent, the location probability likelihood of a set of measurements ηₚ( [symbol] , [symbol] , [symbol] ) can be given by

$$ℙ ( p = {p}^{′} \vert {η}_{p} ( , , 𝒯 ) ) = {\prod }_{k ∈ , b ∈ , t ∈ 𝒯} ℙ ( p = {p}^{′} \vert {RSS}_{p} ( k , b , t ) ) \qquad ( 11 )$$

where [symbol] (p=p′|RSS_{p′}(k, b, t) represents the conditional probability of the UE where P (p =p′RSS, being in position p′ given the measurement in that position. Eq. (11) represents the intersection of multiple probabilities obtained from independently sampling the RSS distributions. To determine [symbol] (p=p′|RSS_{p′}(k, b, t)), i.e. the conditional probability of a UE standing in position p′ is based on database information ( [symbol] _{p′}(k, b)) and a UE measurement RSS_{p′}(k, b, t). Based on the assumption that RSS values follow normal distributions,

$$ℙ ( p = {p}^{′} \vert {RSS}_{p} ( k , b , t ) ) = \frac{1}{σ \sqrt{2 π}} {\int }_{{RSS}_{p} ( k , b , t ) - Δ}^{{RSS}_{p} ( k , b , t ) + Δ} {e}^{- \frac{{( {x}^{′} - {p}_{} ( k , b ) )}^{2}}{2 {σ}^{2}}} {dx}^{′} \qquad ( 12 )$$

with σ=σ_{def}=2 dBm and Δ<<Dᵣₑₛ is half of the interval considered when accumulating probability and Dᵣₑₛ=10⁻³ dBm is the signal strength resolution in the DT database. This integral can be computed programmatically or by using the erfc tables.

Continuing to refer to FIG. 3, a baseline includes a single UE-measured RSS in the best-received beam in a given subband. To obtain the accuracy of the baseline, 1000 times the RSS normal distribution RSSₚ(k, b, t)˜ [symbol] (μₚ(k, b), σₚ(k, b)) for the positions is sampled, and crossed with the respective RF map. The average localization error is shown in FIG. 3. The localization error and the received power (in the best beam and band) correlate at −0.87, suggesting a strong relation between the received power and error. Position 1 303 and position 2 305 are related to LoS and NLoS, respectively. A baseline localization accuracy in these positions is compared with the accuracy achieved using more beams/subbands/times measured.

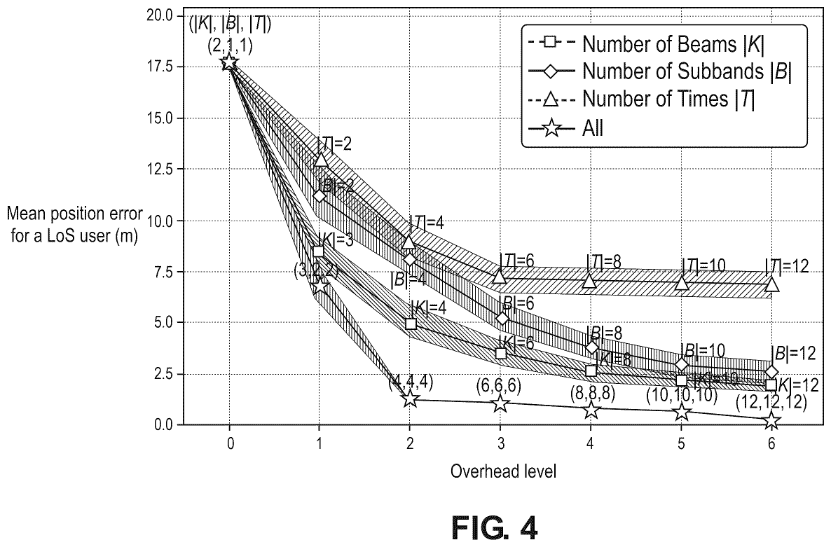

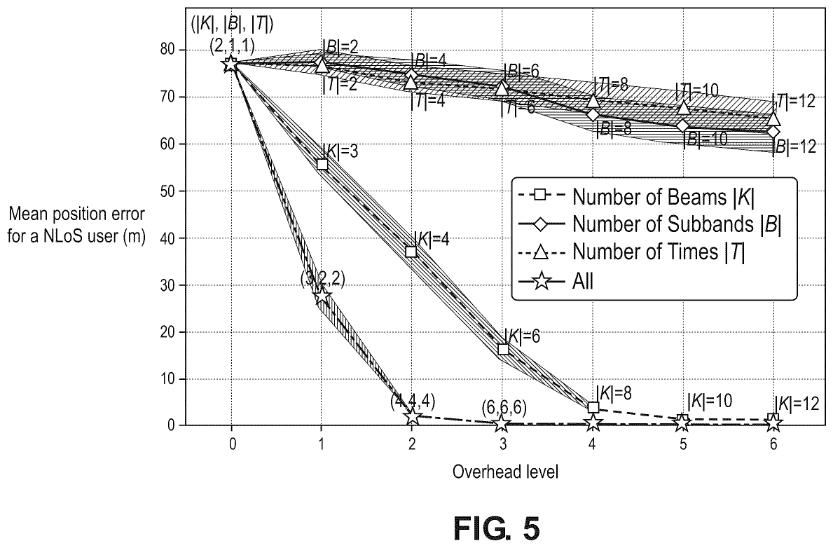

Referring now to FIGS. 4 and 5, the localization error is shown depending on the number of beams | [symbol] | number of subbands | [symbol] | and number of times | [symbol] | measured and reported by the UE. The lines show the impact of the parameters individually (green, blue, and orange lines) and jointly (red lines). As shown, more measurements lead to more localization accuracy. There are different impacts for types of measurement illustrated in FIGS. 4 and 5. More samples across time can be more useful in LoS. The performance improvement from reporting more beams can be more significant in NLoS. These results are examples of the mean localization error in these two positions as the measurements increase.

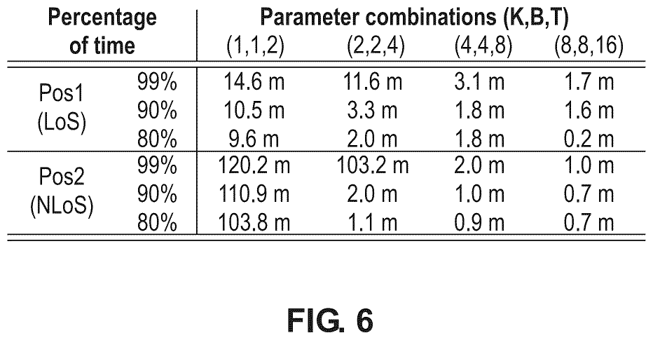

Referring now to FIG. 6, the cumulative distribution values of the horizontal localization error are shown. There are sub-meter accuracies in NLoS 90% of the time.

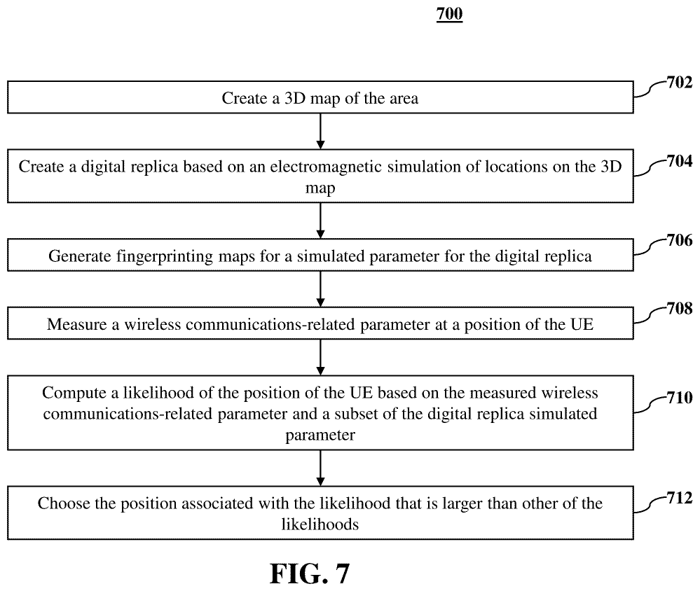

Referring now to FIG. 7, method 700 for localizing user equipment (UE) in an area based on wireless measurements includes, but is not limited to including, creating 702 a 3D map of the area, creating 704 a digital replica based on an electromagnetic simulation of locations on the 3D map, generating 706 fingerprinting maps for a simulated parameter for the digital replica, measuring 708 a wireless communications-related parameter at a position of the UE, computing 710 a likelihood of the position of the UE based on the measured wireless communications-related parameter and a subset of the digital replica simulated parameter, and choosing 712 the position associated with the likelihood that is larger than other of the likelihoods.

As used herein, “electronic communication” means communication of at least a portion of the electronic signals with physical coupling (e.g., “electrical communication” or “electrically coupled”) and/or without physical coupling and via an electromagnetic field (e.g., “inductive communication” or “inductively coupled” or “inductive coupling”). As used herein, “transmit” may include sending at least a portion of the electronic data from one system component to another (e.g., over a network connection). Additionally, as used herein, “data,” “information,” or the like may include encompassing information such as commands, queries, files, messages, data for storage, and the like in digital or any other form.

As used herein, “satisfy,” “meet,” “match,” “associated with”, or similar phrases may include an identical match, a partial match, meeting certain criteria, matching a subset of data, a correlation, satisfying certain criteria, a correspondence, an association, an algorithmic relationship,—‘and/or the like. Similarly, as used herein, “authenticate” or similar terms may include an exact authentication, a partial authentication, authenticating a subset of data, a correspondence, satisfying certain criteria, an association, an algorithmic relationship, and/or the like.

Systems, methods, and computer program products are provided. In the detailed description herein, references to “various embodiments,” “one embodiment,” “an embodiment,” “an example embodiment,” etc. indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. § 112(f) unless the element is expressly recited using the phrase “means for” or “step for”. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

The term “non-transitory” is to be understood to remove propagating transitory signals per se from the claim scope and does not relinquish rights to standard computer-readable media. Stated another way, the meaning of the term “non-transitory computer-readable medium” and “non-transitory computer-readable storage medium” should be construed to exclude only those types of transitory computer-readable media which were found in In re Nuijten to fall outside the scope of patentable subject matter under 35 U.S.C. § 101.

1. A method for localizing user equipment (UE) in an area, the localizing being based on wireless measurements, the method comprising:
creating a 3D map of the area;
creating a digital replica based on an electromagnetic simulation of locations on the 3D map;
generating fingerprinting maps for a simulated parameter for the digital replica;
measuring a wireless communications-related parameter at a position of the UE;
computing a likelihood of the position of the UE based on the measured wireless communications-related parameter and a subset of the digital replica simulated parameter; and
choosing the position associated with the likelihood that is larger than other of the likelihoods.

2. The method of claim 1, wherein the electromagnetic simulation comprises:
ray tracing.

3. The method of claim 1, wherein the wireless communications-related parameter comprises:
a received signal strength.

4. The method of claim 1, further comprising:
creating a digital twin map based on ray tracing in the digital replica.

5. The method of claim 4, further comprising:
calibrating the digital twin map.

6. The method of claim 1, further comprising:
creating a digital twin map based on near real-time measurements and/or sensing data in the area.

7. The method of claim 6, further comprising:
calibrating the digital twin map based on near real-time measurements and/or sensing data in the area.

8. The method of claim 1, further comprising:
basing creating of the 3D map at least on real-time or near real-time dynamics of the area.

9. The method of claim 1, further comprising:
creating a digital twin map based at least on sensed data.

10. The method of claim 1, wherein the 3D map comprises:
a real-time 3D map.

11. A computer system for localizing user equipment (UE) in an area based on wireless measurements comprising:
a hardware processor;
a non-volatile storage medium storing instructions that when executed by the hardware processor perform operations comprising:
creating a 3D map of the area;
creating a digital replica based on an electromagnetic simulation of locations on the 3D map;
generating fingerprinting maps for a simulated parameter for the digital replica;
measuring a wireless communications-related parameter at a position of the UE;
computing a likelihood of the position of the UE based on the measured wireless communications-related parameter and a subset of the digital replica simulated parameter; and
choosing the position associated with the likelihood that is larger than other of the likelihoods.

12. The computer system of claim 11, wherein the electromagnetic simulation comprises:
ray tracing.

13. The computer system of claim 11, wherein the wireless communications-related parameter comprises:
a received signal strength.

14. The computer system of claim 11, wherein the operations further comprise:
creating a digital twin map based on ray tracing in the digital replica.

15. The computer system of claim 14, further comprising:
calibrating the digital twin map.

16. The computer system of claim 11, wherein the operations further comprise:
creating a digital twin map based on near real-time measurements and/or sensing data in the area.

17. The computer system of claim 16, wherein the operations further comprise:
calibrating the digital twin map based on near real-time measurements and/or sensing data in the area.

18. The computer system of claim 11, further comprising:
creating a digital twin map based at least on sensed data.

19. The computer system of claim 11, wherein the 3D map comprises:
a real-time 3D map.

20. A computer program product for localizing user equipment (UE) in an area based on wireless measurements, the computer program product comprising a computer readable storage medium having program instructions embodied therewith, the program instructions executable by a computing device to cause the computing device to perform operations comprising:
creating a 3D map of the area;
creating a digital replica based on an electromagnetic simulation of locations on the 3D map;
generating fingerprinting maps for a simulated parameter for the digital replica;
measuring a wireless communications-related parameter at a position of the UE;
computing a likelihood of the position of the UE based on the measured wireless communications-related parameter and a subset of the digital replica simulated parameter; and
choosing the position associated with the likelihood that is larger than other of the likelihoods.
